(19) United States
(12) Patent Application Publication
(10) Pub. No.: US 2006/0175241 A1
(43) Pub. Date: Aug. 10, 2006

(54) Drain valve insert

(76) Inventors: Leon P Janik, Suffield, CT (US); Stephen J Vardion, Glastonbury, CT (US); Thomas M Tornatore, Enfield, CT (US); Raymond F Anderson, Watertown, CT (US); Michael J Williams, Glastonbury, CT (US)

Correspondence Address: ALIX YALE & RISTAS LLP, 750 MAIN STREET, SUITE 1400, HARTFORD, CT, 06103, US

(21) Appl. No.: 10/564,272

(22) PCT Filed: Feb. 17, 2005
(86) PCT No.: PCT/US05/05062

§ 371 Date: Jan. 10, 2006

(30) Foreign Application Priority Data
Feb. 17, 2004 (US) 60545030

(51) Int. Cl. B01D 27/00

(52) U.S. Cl. 210/299; 210/435

(57) ABSTRACT

A drain valve insert employs a stamped sheet metal body to support a threaded nut in an elevated position over the drain opening of a filter cartridge. Multiple fluid flow passages are defined between the polygonal periphery of the nut and the generally cylindrical sheet metal body of the insert. The insert body defines ledges to support the nut at its periphery corners and includes structures that prevent rotation of the nut relative to the insert body. Retaining arms project upwardly from the insert body and are bent over the nut to axially retain the nut seated against the ledges. The insert body and the nut are inexpensively formed in separate automated operations. Assembly of the nut into the insert body may also be automated.

### BACKGROUND OF THE INVENTION

1. Field of the Invention

This invention relates generally to devices for filtering and separating fluids. More particularly, the present invention relates to fuel filters for removing foreign particles and separating water from the fuel supply of an internal combustion engine.

2. Description of the Related Art

Fuel filters commonly employ a disposable filter cartridge which is replaced at pre-established intervals of filter usage. There are a wide variety of fuel filter cartridge configurations and orientations. The replaceable cartridge is conventionally secured and/or locked to a base by a locking mechanism that is releasable to allow for removal of the cartridge for replacement purposes.

U.S. Pat. No. 5,017,285, which is assigned to the assignee of the present invention, discloses an inverted fuel filter assembly employing a base mounted to the vehicle and a disposable filter cartridge which is suspended directly below the base. The cartridge has a housing constructed of a pair of cup-like sections which are joined along a roll seam. The roll seam functions as a retaining shoulder for engagement by a collar that threads to the base to retain the cartridge in position. The disposable cartridge houses a single or dual stage filter element. The lower portion of the housing forms a sump that collects water separated from the fuel by the filter element. A central axial opening at the bottom of the cartridge housing receives a drain cock. The drain cock threads into an insert that is pressed into the interior lower end of the cartridge housing. Accumulated water is drained from the cartridge by opening the drain cock.

For certain applications, it is highly desirable that a drain bowl for the separated water be provided in conjunction with the fuel filter. The drain bowl functions to provide additional capacity for retaining the separated water. The drain bowl may be constructed of transparent materials that allow exterior inspection of the water level so that the water may be drained from the bowl before maximum capacity is reached, and the effectiveness of the water separating properties of the fuel filter may be monitored.

The conventional employment of a drain bowl in conjunction with a fuel filter cartridge has essentially involved integrating the somewhat bulky drain bowl structure with the filter assembly or the filter cartridge. Naturally, the implementation of an effective fluid seal and the provision of a mounting structure of a structural integrity sufficient to support the bowl are requisite to incorporating a drain bowl into the fuel assembly. In some applications, the filter cartridge is significantly modified so that it will directly accept or mount the drain bowl in a permanent fashion.

A problem associated with the use of drain bowls and the use of drain mechanisms for removing the separated water in general is providing a drain passage structure that will produce a sufficient rate of fluid or water flow. Because the filtering and separating functions of the fuel filter are conducted in a closed structure, in practice the draining of separated water from the cartridge housing tends to occur at a very low rate. The low drain rate can be attributed in part to the relatively small conventional drain openings, the surface tension of the separated water in the vicinity of the drain openings, and the unfavorable pressure differentials exerted on the separated water. In a number of applications that employ a drain bowl, the passage of separated water to the drain bowl is very inefficient and/or the draining of the separated water from the bowl or the cartridge is problematical.

FIG. 1 illustrates a prior art fuel filter assembly 10 incorporating a modular drain bowl 16. The prior art fuel filter assembly 10 comprises a base 12, a disposable cartridge 14 and a modular drain bowl 16 suspended from the filter cartridge 14. The disposable filter cartridge 14 comprises a can-like container constructed from a pair of upper and lower cup-like sections 42, 44 joined at a circumferential roll seam 50. The cartridge 14 is retained to the base 12 by a collar 18 that engages the peripheral roll seam 50. The drain bowl 16 has a modular construction that permits the drain bowl to be mounted and/or dismounted from the filter cartridge at the option of the vehicle operator. The filter cartridge 14 is fully functional with or without the associated drain bowl 16.

In a conventional fashion, filter elements having a continuous fan-shaped pleated configuration are mounted inside the cartridge housing for filtering particulates and separating water from fuel circulated through the filter. A sump 62 is formed at the bottom of the lower section to collect water that coalesces from the fuel. A sump opening 65 is defined by a central axial protrusion 84 of the housing lower section 44.

Cooperative cover and bowl members mate to form a watertight drain bowl enclosure. The cover member has an upper surface with a concave contour that closely mirrors the exterior surface of the lower end of the cartridge 14. The cover member defines an axial recess to accommodate the axial protrusion 84 of the cartridge 14. A compressible seal ring 92 is disposed between opposed shoulders of the cover and bowl members. A second seal ring 98 seals the cover member in fluid tight relationship against the outer surface of the cartridge along a sealing interface surrounding the axial protrusion 84 of the cartridge housing. A third seal ring 101 fluidly seals the tapered recessed shoulder 103 of central bore passing through the bowl member to the mounting bolt 120. The bowl member and optionally the cover member of the drain bowl 16 may be formed of transparent materials, such as plastic, which allow for any water which is collected in the bowl to be readily visible for inspection from an exterior position. A lower off-center portion of the bowl member has a threaded opening for receiving a drain cock 99 to provide a valved drain passage so that collected water may be drained from the bowl as required. The drain cock 99 may have a conventional form and function such as the drain cock conventionally mounted to a filter cartridge for draining the cartridge sump 62.

With additional reference to FIG. 1, the modular bowl 16 is fastened to the cartridge by a mounting bolt 120 threaded to an insert 100 disposed interiorly at the lower end of the cartridge housing adjacent the sump opening 65. The insert 100 includes a contoured lower plug 102 having a lower reduced diameter and an upper enlarged diameter. The lower plug portion is exteriorly contoured to be press fit in the protrusion 84 at the bottom of the cartridge housing. The insert 100 has a drain opening communicating with the sump opening 65. Three equiangularly spaced legs integrally extend from the plug and integrally connect with a platform 110. A central axial opening in the platform is defined by a threaded surface 112. Three angularly spaced apertures 114 are defined between the legs to provide an aspirated drain opening through the drain insert 100 and the cartridge opening 65.

The mounting bolt 120 is inserted through the cover and bowl members to threadably engage the insert 100. The mounting bolt 120 is tightened to axially load the seal rings 98 and 101 to seal the bowl in fluid tight relationship with the cartridge 14. The apertures 114 defined by the insert 100 function as an aspirated opening to facilitate the efficient passage of water collected in the cartridge sump. In addition, the insert 100 can be employed for threadably receiving the drain cock 99 when the modular drain bowl is not desired. The filter assembly 10 is modular in that the drain bowl 16 may optionally be dismounted by unthreading the mounting bolt 120 from the insert 100 and remounting the drain cock 99 at the cartridge opening by threadably engaging the drain cock 99 into the insert 100. The insert 100 in the latter configuration functions to provide an aspirated opening for fluid passage through the drain cock 99.

The relatively thin sheet metal of the filter cartridge housing provides a relatively weak anchoring point for suspending a drain bowl 16 or other components below the filter cartridge 14. The drain bowl 16 should be attached to the cartridge with an axial force sufficient to compress seals 98 and 101, resist vibration induced loosening and withstand forces generated by impacts present in the vehicular environment where the filter assembly is employed.

The drain valve insert should provide both an aspirated drain and an anchoring interface of high integrity. The prior art discloses inserts such as those illustrated in FIGS. 1 and 2. The insert 100 shown in FIG. 1 is a cast metal member. Threads are cut in the central axial opening of the casting to form the threaded surface 112. This manufacturing method provides a high strength insert and a high quality threaded surface. FIG. 2 illustrates an alternative sheet metal insert 200. In this prior art configuration, the insert 200 is a formed sheet metal part. The sheet metal is cut and stamped to define a central axial column 210 supported by legs 216. Multiple openings 214 (one shown) are defined between the angularly spaced legs 216. The several openings 214 provide an aspirated drain. A thread 212 is cut on the inside surface of the central axial column 210 in a separate manufacturing step.

While the drain inserts 100, 200 have proven successful for their intended use, further improvements in manufacturing efficiency are possible while improving the integrity of the resulting anchoring interface.

### SUMMARY OF THE INVENTION

An exemplary embodiment of the invention provides a drain valve insert in which a stamped sheet metal body supports a threaded nut in an elevated position over the drain opening. Multiple fluid flow passages are defined between the polygonal periphery of the nut and the generally cylindrical sheet metal body of the insert. The insert body defines ledges to support the nut at its corners and includes features configured to prevent rotation of the nut relative to the body of the insert. Retaining arms project upwardly from the body and are bent over the nut to axially retain the nut seated against the ledges. The nut efficiently provides a high-strength threaded surface for supporting a drain bowl and its associated hardware. The body of the insert and the nut are inexpensively formed in separate automated operations. Assembly of the nut into the insert body may also be automated. The assembled insert provides a low cost aspirated drain including a high strength threaded anchor.

An object of the invention is to provide a new and improved drain insert for a filter cartridge that includes an aspirated drain.

Another object of the invention is to provide a new and improved drain insert for a filter cartridge that efficiently provides a high strength threaded anchoring surface.

### BRIEF DESCRIPTION OF THE DRAWINGS

Other objects and advantages of the invention will become apparent from the specification and the accompanying drawings, in which:

FIG. 1 is a sectional view of a fuel filter assembly with a modular drain bowl incorporating a prior art drain insert;

FIG. 2 is a sectional view of an alternative fuel filter cartridge incorporating another prior art drain insert;

FIG. 3 is a perspective view of an insert body exemplary of aspects of the present invention;

FIG. 4 is a perspective view of the insert body of FIG. 3 in functional conjunction with a threaded nut exemplary of aspects of the present invention;

FIG. 5 is a perspective view of the insert body and nut of FIG. 4 with the nut secured to the insert body;

FIG. 6 is a top plan view of a further insert body according to aspects of the present invention;

FIG. 7 is a side view of the insert body of FIG. 6;

FIG. 8 is a sectional view of the insert body of FIG. 6, taken along line 8-8 thereof;

FIG. 9 is a sectional view of the insert body of FIG. 6, taken along line 9-9 thereof;

FIG. 10 is a partial sectional view of the insert body of FIG. 6, taken along line 10-10 thereof;

FIG. 11 is a top plan view of another exemplary insert body according to aspects of the present invention;

FIG. 12 is a partial sectional view of the insert body of FIG. 11, taken along line 12-12 thereof;

FIG. 13 is a side view of the insert body of FIG. 11;

FIG. 14 is a sectional view of the insert body of FIG. 11, taken along line 14 -14 thereof;

FIG. 15 is a sectional view of the insert body of FIG. 11, taken along line 15-15 thereof;

FIG. 16 is a sectional view of the insert body of FIG. 11, taken along line 16-16 thereof; and

FIG. 17 is a partial sectional view of a filter cartridge lower section equipped with a drain valve insert according to aspects of the present invention.

### DETAILED DESCRIPTION OF THE PREFERRED EMBODIMENT

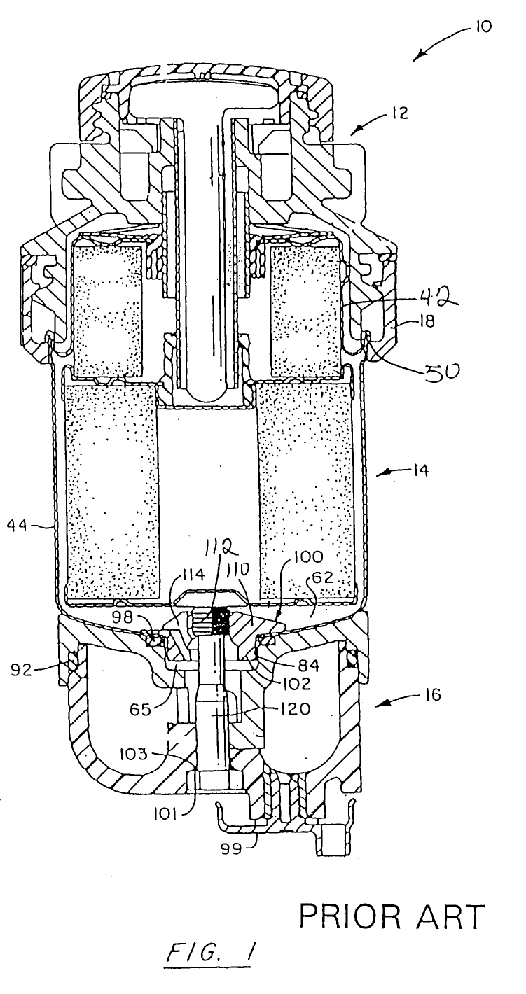

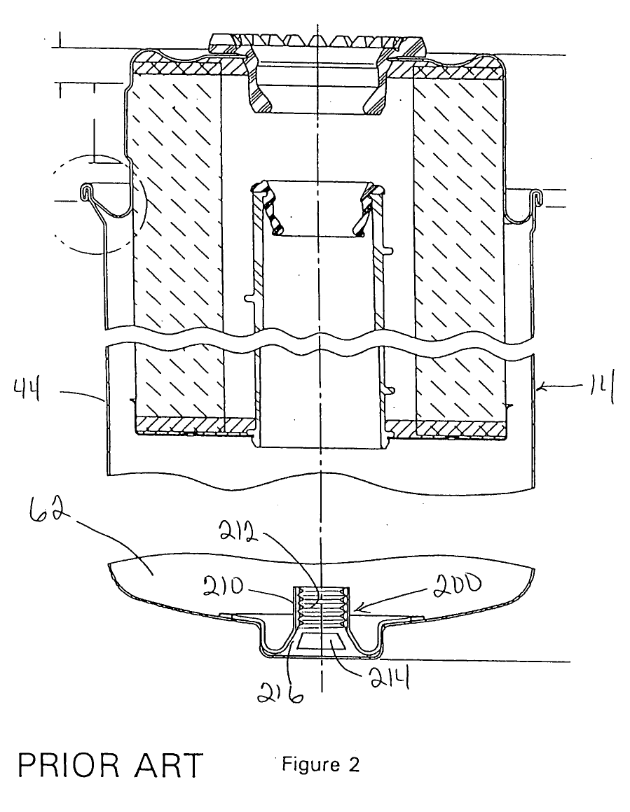

The filter assembly 10 of FIG. 1 is a representative fuel filter cartridge incorporating a prior art drain valve insert 100. FIG. 2 illustrates an alternative prior art drain valve insert 200 for a filter cartridge. FIGS. 3-5 illustrate the components and assembly of an exemplary drain valve insert 300 according to aspects of the present invention. The drain valve insert 300 is an assembly of a threaded nut 70 into a formed sheet metal body 20. The sheet metal of the illustrated sheet metal body 20 is approximately 0.036″ thick. Incorporating a nut into the drain valve insert according to aspects of the present invention reduces the cost and complexity of manufacturing a drain valve insert having both an aspirated drain opening and a high quality threaded anchoring point.

Square threaded nuts such as 70 are mass-produced and are commercially available at low cost. The nut 70 has a central opening 72 defined by a threaded surface 74. Since this central, threaded opening 72 will be occupied, the drain insert 300 defines a plurality of fluid flow passages 80 radially outwardly of the axial opening 72 in the nut. The nut 70 is secured to the insert body 20 to prevent axial and rotational movement relative to the body. The means by which rotational movement of the nut is prevented should be sufficiently robust to resist rotation of the nut during installation or removal of a drain cock or drain bowl. A square threaded nut is illustrated, however other nut shapes, such as hexagonal or non-polygonal shapes with anti rotation features are within the scope of the present invention.

FIG. 3 illustrates a first exemplary embodiment of a drain insert body 20 in accordance with aspects of the present invention. The illustrated drain insert body 20 is configured to support the nut 70 at each of its four corners 76. The basic configuration of the drain insert body is that of a wide rimmed bowl with an open bottom. The open bottom defines a drain opening 30. The rim of the bowl provides a radially extending flange 22 for supporting the insert against the inside bottom surface of the filter cartridge lower section 44. The side wall 32 of the bowl-shape is substantially cylindrical with an outside diameter selected to be closely received in a downwardly protruding portion 84 of the filter cartridge lower section 44. The outside surface of the drain insert body 20 is configured to facilitate a press fit installation in the bottom of the cartridge lower shell section 44. A sealant and/or adhesive may be applied between the drain insert body 20 and the lower housing section 44 to promote a sealed engagement between these parts. Thus, the only means of egress for fluid from a filter cartridge 14 equipped with the inventive drain valve insert 300 is through the axial drain opening 30 communicating with the sump opening 65 defined by the lower housing section 44. The large surface area of the insert body and rim 22 provides a strong force-spreading interface with the lower housing section 44.

With continuing reference to FIGS. 3-5, the side wall 32 of the insert body 20 is cut and deformed inwardly at four equiangularly spaced locations to define ledges 26 for axially supporting the corners of the nut 70. The inwardly displaced material of each ledge 26 is then deformed downwardly to provide angularly spaced shoulders 28 on either side of the ledge 26. The ledge supports the nut 70 approximately one tenth of an inch (0.1″) above the bottom inside surface of the insert body.

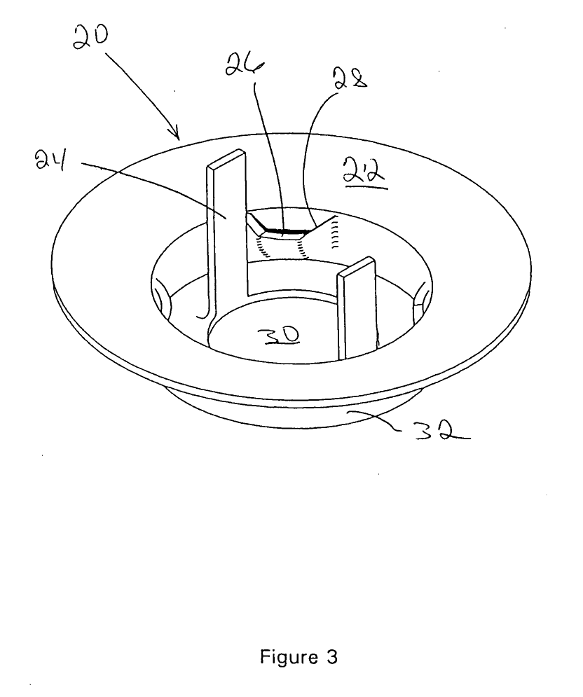

The insert body 20 also includes two retaining arms 24 extending axially upwardly from opposite sides of the drain opening 30. The retaining arms 24 have an axial length that extends above the top surface of a nut 70 resting on the ledges 26 of the insert body 20 as shown in FIG. 4. The retaining arms 24 are bent over the top surface of the nut 70 to trap the nut 70 in its installed position as shown in FIG. 5. The nut 70 is held in position to allow engagement of a drain cock or fastener for supporting a drain bowl from below the cartridge 14. Tightening the drain cock or drain bowl fastener imparts an axially downward and rotational force to the nut. The upwardly projecting shoulders 28 prevent rotation of the nut 70 relative to the insert body 20. The nut 70 and insert body 20 of the illustrated drain valve insert 300 are efficiently mass-produced in separate operations. Assembly of the nut to the insert body may be automated.

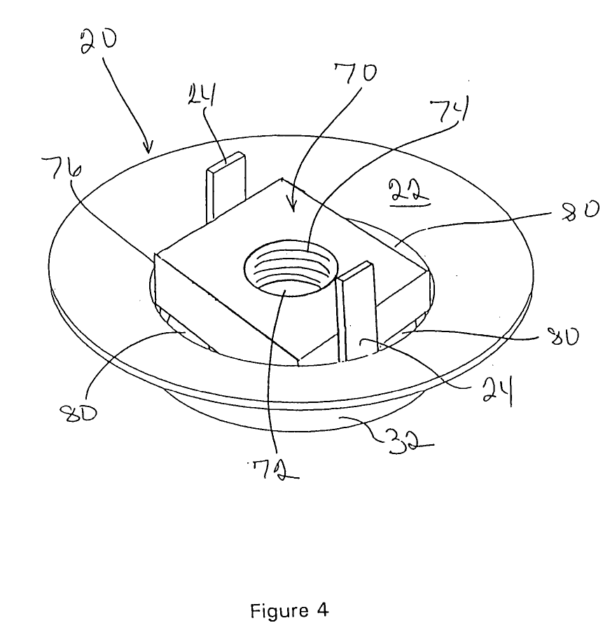

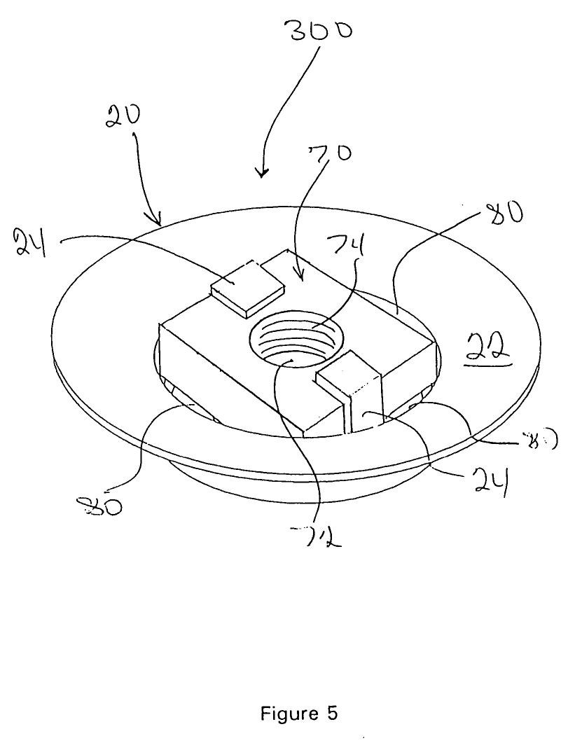

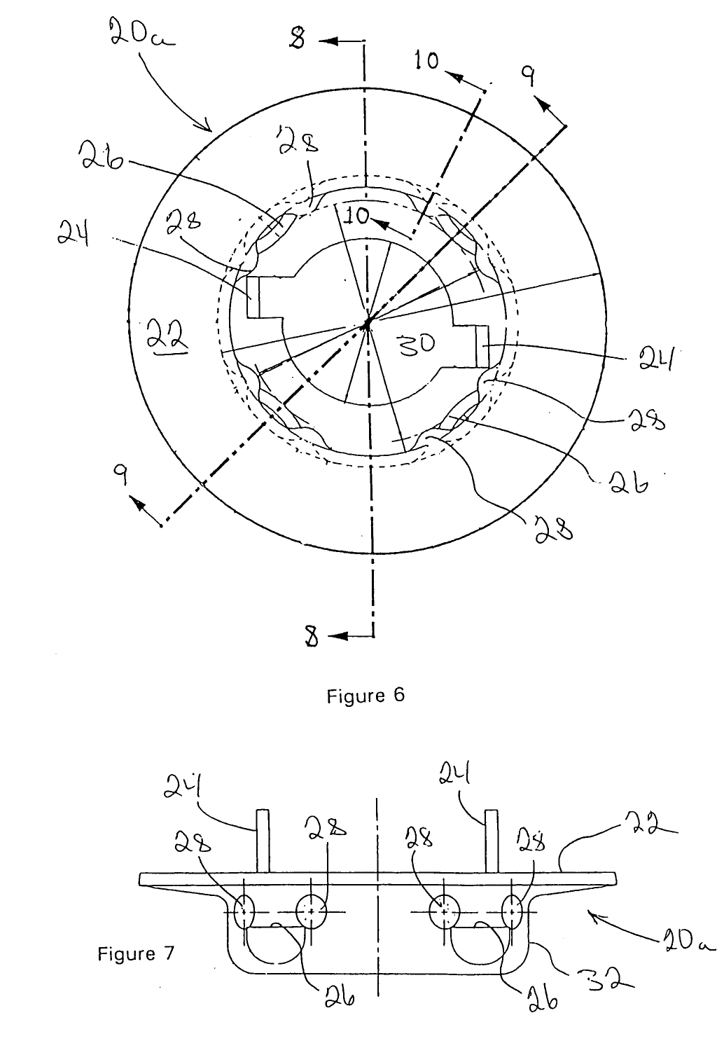

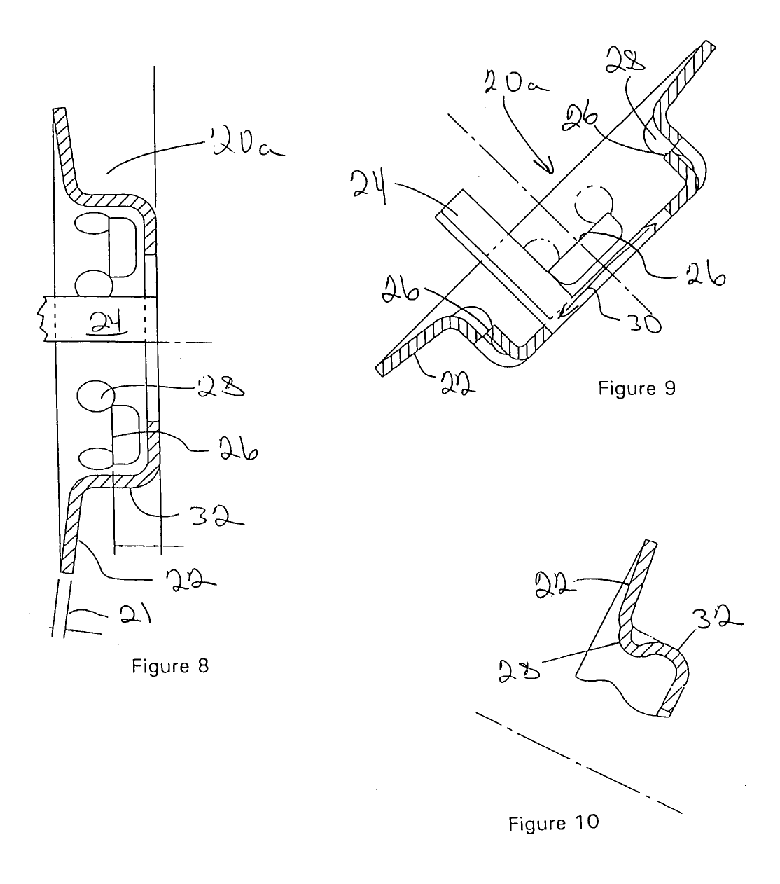

FIGS. 6-10 illustrate an alternative insert body 20a. Insert body 20a is substantially identical to insert body 20 with the exception of the configuration of the inwardly projecting ledge 26 and angularly spaced shoulders 28. For insert body 20a, the inwardly projecting ledge 26 is formed as a horizontal cut and inwardly displaced part of the vertical wall 32 best seen in FIG. 9. As best seen in FIGS. 6 and 10, the angularly spaced shoulders 28 are provided by inwardly projecting dimples above the ledge 26. The vertical wall 32 of the insert body 20a is inwardly deformed to define the shoulders 28.

An aspect of the present invention relates to formation of the retaining arms 24. As best seen in FIG. 6, the retaining arms are diametrically offset from each other, e.g., each retaining arm is formed from a different half of the sheet metal comprising the insert body. The arms would extend along side each other from opposite sides of the drain opening 30 prior to bending to their vertical orientation as shown in FIGS. 3, 4, 7, and 9. This arrangement permits each arm's axial length to be formed from insert body material that would otherwise be removed to define the drain opening 30. In accordance with aspects of the present invention, the retainer arms 24 are cut from the removed material and bent into the configuration shown in FIGS. 3 and 7. The retainer arms 24 originate radially outwardly from the lip of the drain opening 30. The offset, set back configuration described above provides retaining arms with the needed axial length from sheet metal of the insert body 20.

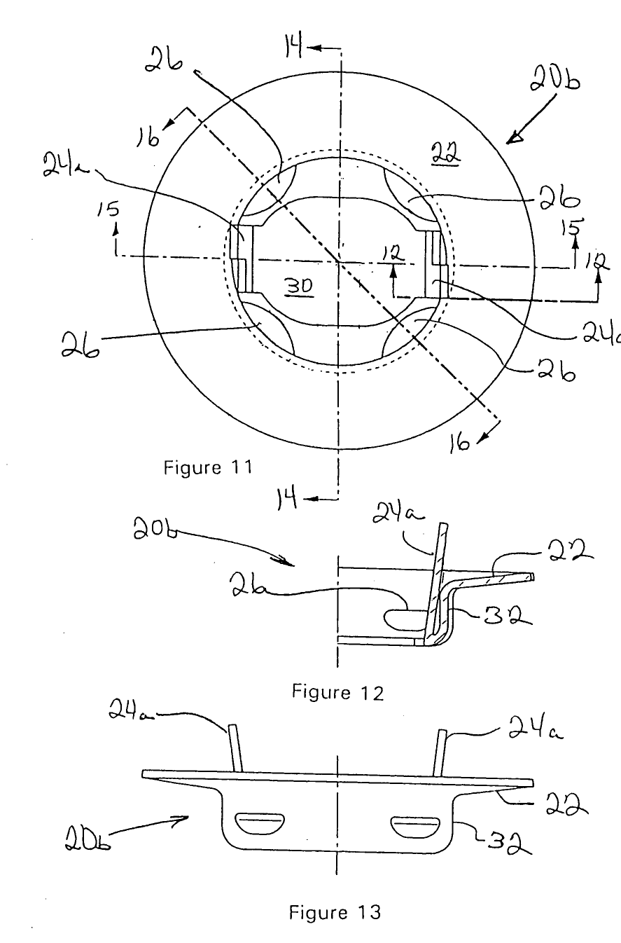

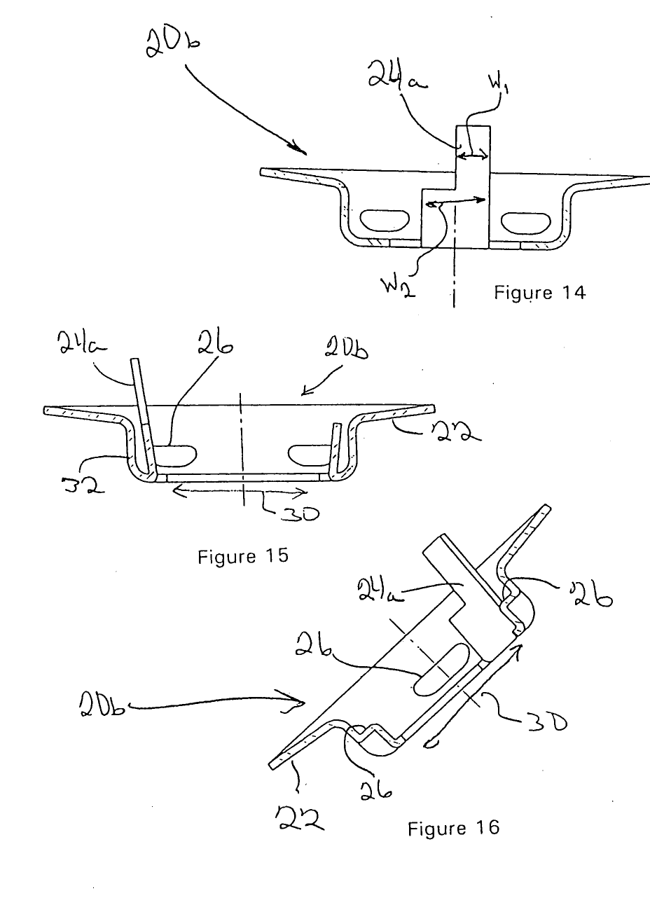

FIGS. 11-17 illustrate a further insert body embodiment 20b. Inwardly displaced portions of the vertical wall 32 form the ledges 26 of insert body 20b. The ledges 26 are formed without cutting the side wall 32 as best seen in FIG. 16. The ledges 26 are arranged to support the four corners of a nut as discussed with respect to insert bodies 20 and 20a. Insert body 20b eliminates the angularly spaced shoulders 28 adjacent the ledges 26 of insert bodies 20 and 20a in favor of laterally expanded retaining arms 24a. The lower portion of retaining arms 24a are laterally expanded to a width W₂ to resist rotation of a received nut relative to the insert body 20b. The retaining arm upper portion has a smaller width W₁ of sufficient strength to retain a received nut against the relatively modest upward axial loads generated during installation of a drain cock or drain bowl. The tip of the retaining arm upper portions are bent over a received nut as illustrated in FIG. 5. The retaining arms 24a are arranged so that the laterally expanded lower portions bear on opposed sides of a received nut so as to resist rotation of the nut and eliminate the need for the shoulders 28 of the other insert body embodiments 20, 20a. The basic shape and function of insert body 20b is similar to that described for insert bodies 20, 20a except as described above.

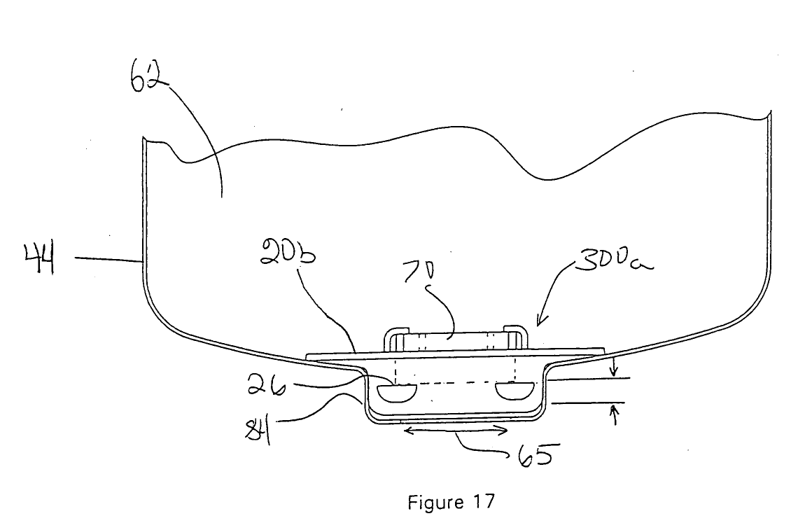

As best seen in FIGS. 4 and 5, multiple fluid flow openings 80 are defined between the polygonal periphery of the nut 70 and the generally cylindrical inside surface of the drain valve insert 20. These multiple fluid flow openings 80 provide an aspirated drain for efficient movement of fluid from the cartridge sump 62 out of a drain cock or into a drain bowl. FIG. 17 illustrates a drain valve insert 300a in which the ledges 26 support the nut 70 above the bottom surface of insert body 20b. This relationship allows the fluid flow passages defined between the perimeter of the nut 70 and the inside surface of the insert body 20b to communicate with the opening 65 defined by the lower cartridge section 44.

While retainer arms are disclosed, other retaining means, such as welding, brazing, crimping, or a retaining ring seated in an internal groove might occur to those of skill in the art and are intended to be encompassed by the present invention. The ledge 26, shoulders 28 and retaining arm 24 configurations of insert bodies 20, 20a and 20b are representative examples and are not limiting of the disclosed invention. Many variations of the disclosed structures will occur to those of skill in the art without departing from the spirit and the scope of the present invention.

While illustrated embodiments of the present invention have been described for the purpose of illustration, the foregoing descriptions should not be deemed a limitation of the invention herein. Accordingly, various modifications, adaptations and alternatives may occur to one of skill in the art without departing from the spirit and the scope of the present invention.

What is claimed is:

1. A filter cartridge comprising:
a housing extending between axially spaced ends to define an interior space, a fluid circulation opening at a first axial end and a sump opening at a second axial end;
a filter element supported in said interior space intermediate said fluid circulation opening and said sump opening;
a drain insert adjacent said sump opening, said drain insert comprising:
an insert body with inside and outside surfaces and defining a drain opening, said inside surface having an inwardly projecting ledge defining a support surface axially spaced from said drain opening;
a nut having top and bottom surfaces connected by a peripheral surface and defining a threaded axial opening; and
a drain control element threadably engaged in said threaded axial opening,
wherein said nut is fixed to said insert body with at least a portion of said polygonal peripheral surface resting on said support surface, at least one fluid flow passage being defined between said insert body inside surface and said peripheral surface, said fluid flow passages communicating with said drain opening and said drain insert is secured to said housing adjacent said sump opening with said drain opening in communication with said sump opening.

2. The filter cartridge assembly of claim 1, wherein said drain control element comprises a drain cock which, when tightened blocks fluid flow through said sump opening and when loosened permits fluid flow through said sump opening.

3. The filter cartridge assembly of claim 1, wherein said drain control element comprises a drain bowl fastened to an outside surface of said housing by a fastener engaged with said threaded axial opening.

4. The filter cartridge of claim 1, wherein said support surface comprises a plurality of angularly spaced inwardly displaced portions of said insert body.

5. The filter cartridge of claim 4, wherein said peripheral surface is defined by a regular polygon and includes a plurality of corners and each said inwardly displaced portion defines a support surface portion flanked by inwardly projecting shoulders, each inwardly displaced portion receiving a corner of said nut between said shoulders whereby nut is substantially rotationally fixed relative to said insert body.

6. The filter cartridge of claim 1, wherein said housing comprises upper and lower sections joined at a peripheral roll seam, said lower section including a central axial protrusion surrounding said sump opening, said insert body comprising a generally cylindrical axial wall configured to be closely received in said central axial protrusion and said ledge projects inwardly from said axial wall.

7. The filter cartridge of claim 1, wherein said insert body comprises retaining arms projecting axially from opposed locations adjacent said drain opening, said retaining arms extending axially above said nut top surface and being bent against said top surface to retain said nut against said ledges.

8. The filter cartridge of claim 1, wherein said insert body is formed from sheet metal having a thickness of approximately 0.036″.

9. The filter cartridge of claim 1, wherein said insert body comprises retaining arms projecting axially from opposed locations adjacent said drain opening, said retaining arms having an upper portion extending axially above said nut top surface and being bent against said top surface to retain said nut against said ledges and a lower portion, said lower portion having a lateral width greater than a lateral width of said upper portion.

10. A drain valve insert for use in conjunction with a filter cartridge, said drain valve insert comprising:
an insert body having an inside surface, an outside surface and defining a drain opening, said inside surface including an inwardly projecting ledge, said ledge defining a support surface axially spaced from said drain opening; and
a nut having a periphery and defining a threaded axial opening;
wherein said nut is fixed to said insert body with said periphery supported by said support surface, at least one fluid flow passage being defined between said insert body inside surface and the periphery of said nut, said at least one fluid flow passage communicating with said drain opening.

11. The drain valve insert of claim 10, wherein said insert body includes retaining arms projecting axially from opposed locations adjacent said drain opening, said retaining arms extending axially above said nut and being bent over said nut to retain said nut against said ledge.

12. The drain valve insert of claim 11, wherein said retaining arms have an upper portion at a first width and a lower portion at a second width greater than said first width.

13. The drain valve insert of claim 10, wherein said ledge comprises a plurality of angularly spaced ledges and said inside surface includes angularly spaced shoulders flanking each ledge, said shoulders configured to resist rotation of said nut relative to said insert body.

14. The drain valve insert of claim 10, wherein said nut is square and said insert body includes four ledges arranged to support each corner of said square nut.

15. The drain valve insert of claim 10, wherein said insert body is formed from sheet metal.

16. The drain valve insert of claim 10, wherein said nut defines a threaded axial opening.

17. A drain insert comprising:
an insert body defining a generally cylindrical cavity surrounding an axial opening, said cavity having an inside surface including an inwardly projecting ledge axially spaced from said opening; and
a nut having a periphery and defining a threaded central aperture;
wherein said nut is fixed to said insert body with at least a portion of said periphery resting on said ledge and a plurality of passages defined between said periphery and said inside surface, said passages communicating with said opening.

18. The drain insert of claim 17, wherein said insert body includes retaining arms projecting axially from opposed locations adjacent said drain opening, said retaining arms extending axially above said nut and being bent over said nut to retain said nut against said ledges.

19. The drain insert of claim 18, wherein said retaining arms have an upper portion at a first width and a lower portion at a second width greater than said first width.

20. The drain insert of claim 17, wherein said inwardly projecting ledge comprises a plurality of angularly spaced inwardly displaced portions of said insert body.
